(19) United States
(12) Patent Application Publication
(10) Pub. No.: US 2009/0045550 A1
(43) Pub. Date: Feb. 19, 2009

(54) TRANSCRIPTION MOLD FIXATION APPARATUS AND SUBSTRATE REMOVING METHOD

(75) Inventors: Hiroaki TAMURA, Kawasaki (JP); Mitsuo TAKEUCHI, Kawasaki (JP); Ken-ichi ITOH, Yamato (JP); Hideyuki KIKUCHI, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/190,293

(22) Filed: Aug. 12, 2008

(30) Foreign Application Priority Data
Aug. 14, 2007 (JP) 2007-211279

(51) Int. Cl. B29C 39/36

(52) U.S. Cl. 264/334; 425/441

(57) ABSTRACT

According to an aspect of an embodiment, a transcription mold fixation apparatus includes a support base, a magnet, a pin, and a regulating mechanism. The support base receives, on a surface thereof, a transcription mold having a center hole formed therein and containing a magnetic material, and the support base has a through hole aligned to the center hole. The magnet is incorporated in the support base, and fixes the transcription mold to the surface of the support base. The pin extends through the through hole. The regulating mechanism causes the magnet to be spaced apart from the magnetic material.

### CROSS-REFERENCE TO RELATED APPLICATIONS

This application is based upon and claims the benefit of priority of the prior Japanese Patent Application No. 2007-211279 filed on Aug. 14, 2007, the entire contents of which are incorporated herein by reference.

### BACKGROUND

1. Field

An aspect of the invention relates to a transcription mold fixation apparatus and a substrate removing method that are used for the manufacture of patterned media.

2. Description of the Related Art

So-called patterned media are widely known. A patterned medium is used for a magnetic recording medium, such as a magnetic disk, which includes magnetic grains regularly arranged at equal intervals. Such a magnetic disk includes a non-magnetic alumina film. The alumina film includes a large number of bottomed pores or nanoholes formed therein. The nanoholes are arranged on the alumina film in a regular manner. Magnetic grains are arranged in the respective nanoholes. Magnetic information is recorded on the respective magnetic grains. Using such a patterned medium improves the record density of the magnetic disk.

A patterned medium is manufactured in such a manner that an alumina film is formed on a transcription mold that includes a predetermined pattern on its surface. With the transcription mold, since fine grains are regularly arranged, predetermined patterns or multiple depressions are transferred on the surface of the aluminum film. After transcription, the aluminum film is separated from the transcription mold. In regard to separation of such a transcription mold, research and studies are under way for better methods of holding the transcription mold.

### SUMMARY

According to an aspect of an embodiment, a transcription mold fixation apparatus includes a support base that receives on a surface thereof a transcription mold having a center hole formed therein and containing a magnetic material, and that includes a through hole formed to be connected to the center hole, a magnet that is incorporated in the support base and that fixes the transcription mold to the surface of the support base, a pin that passes through the through hole, and a regulating mechanism that causes the magnet to be spaced apart from the magnetic material.

Additional objects and advantages of the invention will be set forth in part in the description which follows and, in part will be obvious from the description, or may be learned by practice of the present invention. The object and advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

FIG. 1 shows the structure of a fixation apparatus;

FIG. 2 is a cross sectional view taken along the line 2-2 of FIG. 1;

FIG. 3 is a plan view taken along the line 3-3 of FIG. 2.

FIG. 4 is a cross sectional view taken along the line 4-4 of FIG. 3;

FIG. 5 is an exploded perspective view of the fixation apparatus;

FIG. 6 is a schematic perspective view showing a manner in which the transcription mold is fixed to a surface of an upper base;

FIG. 7 is a schematic cross sectional view showing a manner in which the transcription mold is fixed to the surface of the upper base;

FIG. 8 is a schematic cross sectional view showing a manner in which a substrate is disengaged from the transcription mold;

FIG. 9 is a schematic cross sectional view showing a manner in which a lower base is removed from the upper base;

FIG. 10 is a cross sectional view showing a modified example of the fixation apparatus using an aspect of the invention; and

FIG. 11 is a schematic cross sectional view showing the structure of a fixation apparatus.

### DETAILED DESCRIPTION

### First Embodiment

A first embodiment of the invention will be described herebelow with reference to the accompanying drawings.

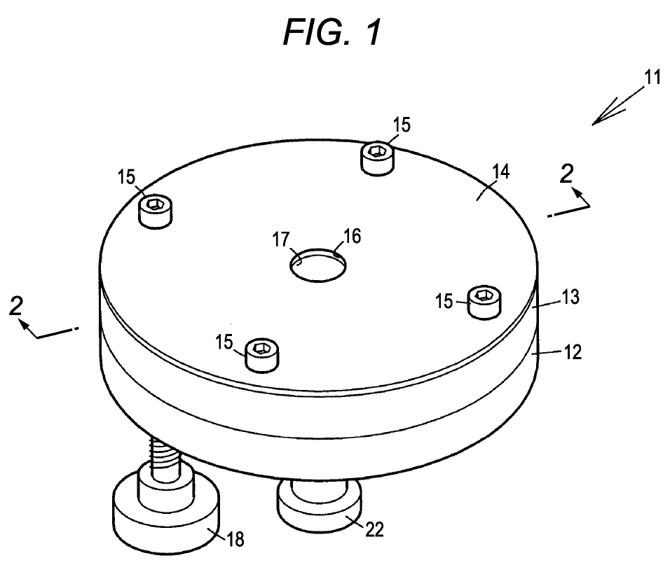

FIG. 1 is a schematic view of the exterior of a fixation apparatus 11 according to the first embodiment. The fixation apparatus 11 is used to fix a transcription mold. The fixation apparatus 11 is used to peel off or separate a substrate unit mounted to the transcription mold from the transcription mold. The fixation apparatus 11 includes a lower base 12 having a disc shape. An upper base 13 is overlapped on a surface of the lower base 12. A central axis of the lower base 12 aligns with a central axis of the upper base 13. The lower base 12 is immobility fixed to a support member (not shown). In contrast, the upper base 13 is coupled to the support member to be vertically movable along the central axis of the upper base 13. The lower base 12 is formed from a magnetic metal material such as iron. The upper base 13 is formed from a non-magnetic material such as aluminum.

A sheet 14 having a predetermined thickness is overlapped on a surface of the upper base 13. The sheet 14 is formed from a resin or metal material, for example. The sheet 14 is attached to the surface of the upper base 13 by the use of four screws 15. However, the number of the screws 15 is not limited to four. The screws 15 are inserted into respective threaded screw holes (not shown) formed in the upper base 13. An opening 16 in the shape of a circle (regular circle) is formed in the center of the sheet 14. A through hole 17 in the shape of a circular pillar, extending from the reverse face of the upper base 13 to the surface thereof is coupled to the inside of the opening 16. The diameters of the opening 16 and the through hole 17 are equally set.

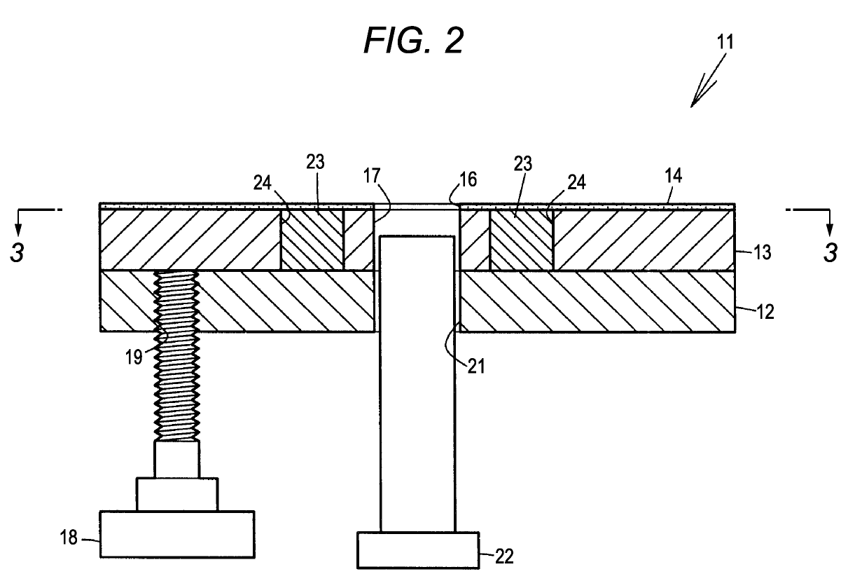

FIG. 2 is a cross sectional view of the fixation apparatus 11 taken along the line 2-2 of FIG. 1. Referring also to FIG. 2, a screw 18 is correlated to the lower and upper bases 12 and 13. The screw 18 is inserted into a threaded screw hole 19, which extends from the reverse face of the lower base 12 to the surface thereof. In the present embodiment, the screw 18 is formed from a metal material. A central axis of the threaded screw hole 19 is perpendicular to the surface of the lower base 12. The threaded screw hole 19 is blocked by the reverse face of the upper base 13 on the surface of the lower base 12. As a consequence, when the screw 18 is fully inserted into the threaded screw hole 19, the leading end of the screw 18 is abutted on the reverse face of the upper base 13. The lower base 12, the screw 18, and the threaded screw hole 19 together configure a regulating mechanism.

The through hole 17 is coupled to a through hole 21 having a circular pillar shape extending from the reverse face of the lower base 12 to the surface thereof. The diameter of the through hole 17 of the upper base 13 and the diameter of the through hole 21 of the lower base 12 are set to be equal to each other. More specifically, the diameter of the through hole 17 or 21 is set to 8.0 mm, for example. In the state that the upper base 13 is overlapped on the surface of the lower base 12, the central axis of the through hole 17 aligns with the central axis of the through hole 21.

A circular-pillar shaped pin 22 is inserted into the through holes 17 and 21. The pin 22 is formed from a resin material, for example. The pin 22 moves inside the through holes 17 and 21 along the direction of the axis of the pin 22. The movement of the pin 22 is guided by the through holes 17 and 21. In order to facilitate the movement of the pin 22 inside the through holes 17 and 21, the diameter of the pin 22 is set smaller than the diameters of the respective through holes 17 and 21. More specifically, the diameter of the pin 22 is set to 7.5 mm, for example. Thus, in the state of the pin 22 inserted in the through holes 17 and 21, a leading edge of the pin 22 is extended from the surface of the upper base 13, or more specifically, from the opening 16 of the sheet 14.

Multiple magnets 23 are incorporated around the through hole 17 of the upper base 13. The magnet 23 is permanent magnet such as a Neodymium magnet. In the state that the upper base 13 is overlapped on the surface of the lower base 12, the magnet 23 is disposed inside a circular-pillar shaped through hole 24 extending from the surface of the upper base 13 to the reverse face thereof. The central axis of the through hole 24 is perpendicular to the surfaces of the lower and upper bases 12 and 13. The thickness of the magnet 23 is set to be equal to the thickness of the upper base 13. The magnet 23 is fixed to the surface of the lower base 12. An adhesive is used to fix the magnets 23 to the lower base 12.

As described above, however, since the lower base 12 is formed from the magnetic metal material, the magnet 23 may be securely, intensively fixed to the surface of the lower base 12 by magnetic forces of the magnets 23. In the case where the magnets 23 are fixed to the lower base 12 by the magnetic forces, the adhesive does not have to be used to fix the lower base 12 and the magnet 23 to each other. As a consequence, occurrence of, for example, the occurrence of unnecessary foreign matter and contamination associated with the adhesive can be prevented.

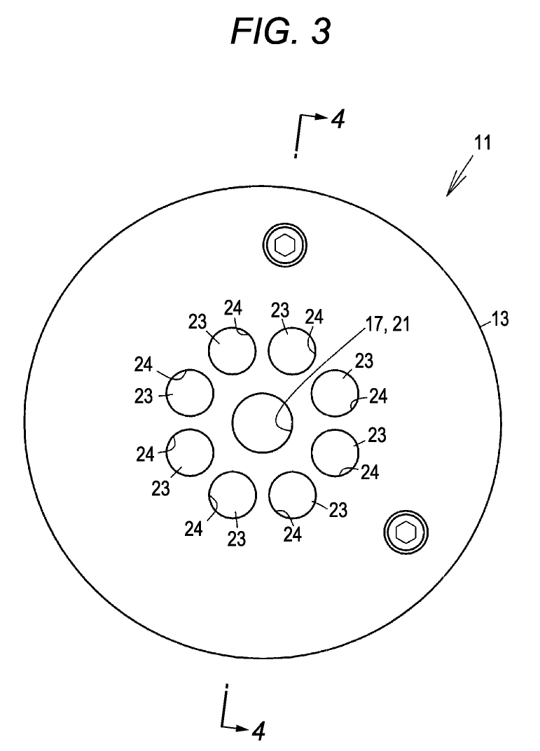

FIG. 3 is a plan view of the fixation apparatus 11 taken along the line 3-3 of FIG. 2. With reference to FIG. 3, each magnet 23 is formed into a circular pillar shape. The sets of the magnets 23 and the through holes 24 are equally disposed around the through hole 17 or 21. More specifically, the sets of the magnets 23 and the through holes 24 are disposed in a virtual regular circle centered on the central axis of the through hole 17 or 21. In the example shown in FIG. 3, four sets of the magnet 23 and the through hole 24 are disposed at an equal interval of 45 degrees around the central axis of the through hole 17. Thus, the magnets 23 are disposed to surround the circumference of the through hole 17 or 21. That is, the magnets 23 of the present embodiment are disposed inside the virtual regular circle concentric with the central axis of the through hole 17 or 21. The diameter of the virtual regular circle is set to one inch, for example. More specifically, the diameter is set corresponding to the diameter of a magnetic disk being manufactured.

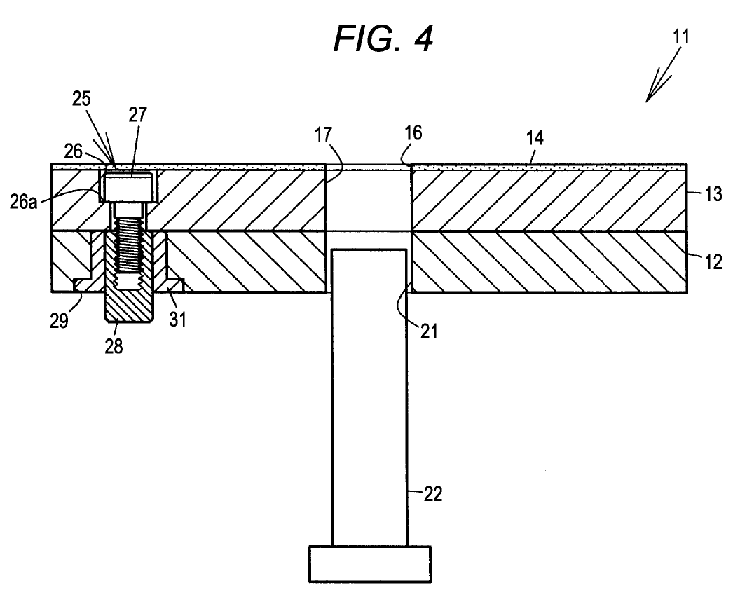

FIG. 4 is a cross sectional view of the fixation apparatus 11 taken along the line 4-4 of FIG. 3. With reference to FIG. 4, the lower base 12 and the upper base 13 are coupled together by a coupling mechanism 25. The coupling mechanism 25 includes a bolt 27 that is disposed inside a receiving hole 26 extending from the surface of the upper base 13 to the reverse face thereof. A stepped face 26a is formed inside the receiving hole 26. The diameter of the receiving hole 26 is changed bordering on the stepped face 26a. A screw head of the bolt 27 is received in a large-diameter section, whereas a screw stem of the bolt 27 is received in a small-diameter section of the receiving hole 26. Consequently, the screw head of the bolt 27 is received by the stepped face 26a in the receiving hole 26. The screw stem of the bolt 27 is inserted into a threaded screw hole formed in a spacer 28. An upper end of the spacer 28 is received by the reverse face of the upper base 13. In this manner, the spacer 28 is attached to the bolt 27 and is thereby attached to the upper base 13. The spacer 28 is received into a bush 31 disposed in a receiving hole 29 that extends from the reverse face of the lower base 12 to the surface thereof. The spacer 28 is movable inside the bush 31 along the axial center of the bush 31.

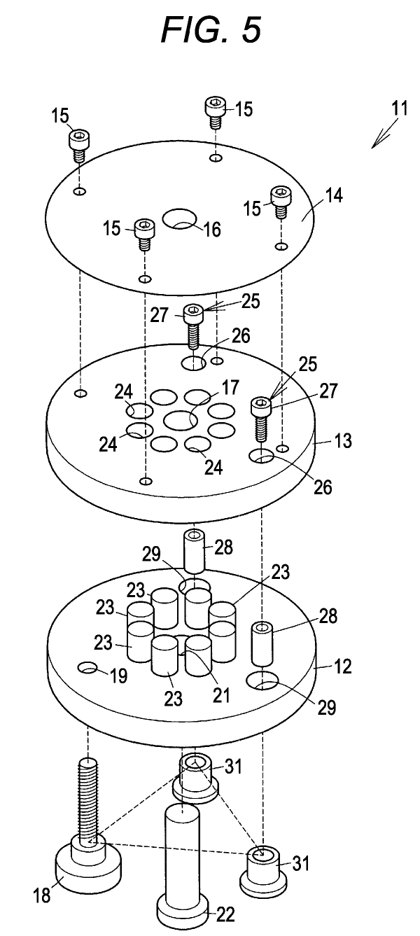

FIG. 5 is an exploded perspective view of the fixation apparatus 11 of the present embodiment. With reference to FIG. 5, the lower and upper bases 12 and 13 are coupled together by a pair of the coupling mechanisms 25. Further, the threaded screw hole 19 for receiving the screw 18 inserted and the coupling mechanisms 25, for example, are disposed external of the magnets 23. In the present embodiment, the screw 18 and the coupling mechanisms 25, respectively, are disposed at apexes of a virtual triangle. The virtual triangle is defined by a virtual equilateral triangle. The center of the virtual triangle is coincident with the central axis of the through hole 17 or 21.

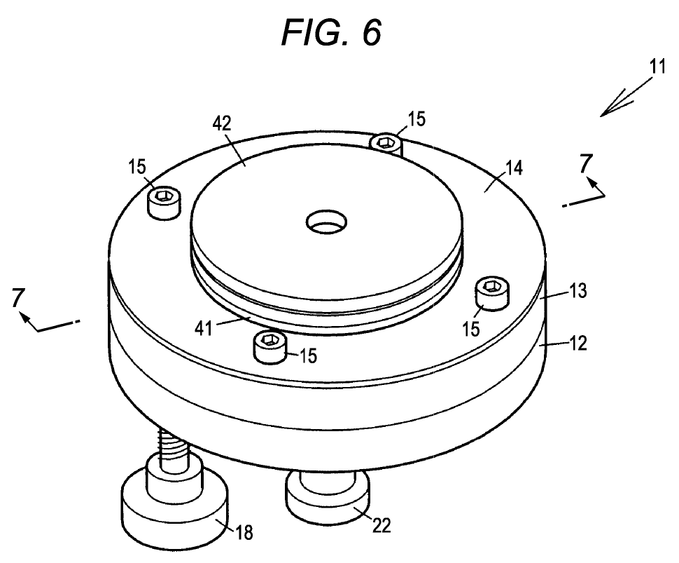

A method of using the fixation apparatus 11 will be described below. With reference to FIG. 6, a transcription mold 41 having, for example, a disc shape is disposed on the surface of the upper base 13. However, the shape of the transcription mold 41 is not limited to the disc shape. Further, a disc-shaped transcription mold 41 is preliminarily disposed on the surface of the transcription mold 41 disposed on the surface of the upper base 13.

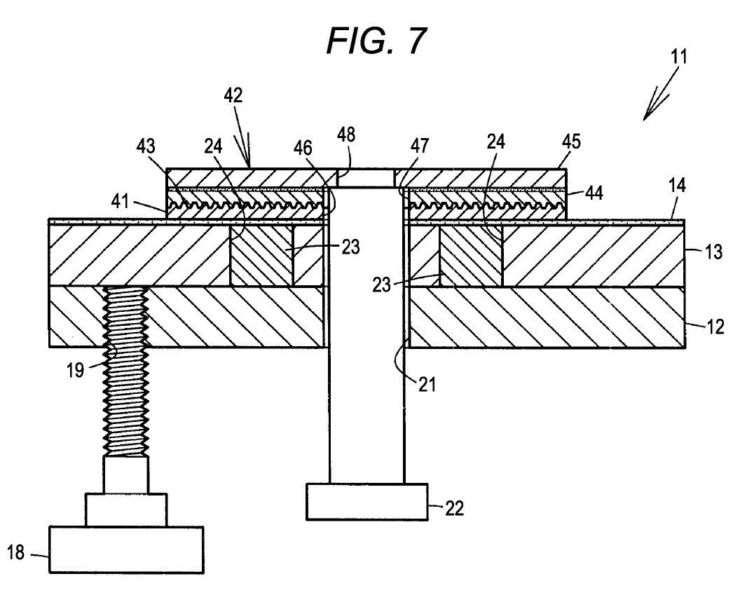

The transcription mold 41 includes a magnetic material such as Ni, for example. In the present case, the transcription mold 41 is formed from a Ni simplex material. However, the configuration may be such that, when the transcription mold 41 is on the upper base 13, magnetic members of a different material are attached to the body of a transcription mold formed from a material different from the above-described. Referring also to FIG. 7, a transfer pattern 43 is (preliminarily) formed on the surface of the transcription mold 41. The transfer pattern 43 includes, for example, predetermined protrusions and depressions corresponding to the shapes of recording tracks of the magnetic disk. The transfer pattern 43 maybe formed through, for example, electron beam irradiation. However, the transfer pattern 43 may be formed on the transcription mold 41 by a different method. For example, the transcription mold 41 may be formed in the manner that a Ni layer is formed on a mold on which a transfer pattern is formed, and the Ni layer is separated from the mold. The transcription mold 41 has a diameter of one inch, for example. The size and the shape of the transcription mold 41 can be appropriately changed corresponding to a target on which the transfer pattern 43 is to be transferred.

The substrate unit 42 includes a to-be-transferred film, namely, an aluminum film 44, which is formed by lamination on the surface of the transcription mold 41. For example, a well-known sputtering process is executed for forming the aluminum film 44 onto the transcription mold 41. Since the transfer pattern 43 is already formed on the surface of the transcription mold 41, the transfer pattern is transferred onto the aluminum film 44. The substrate unit 42 further includes a substrate 45. After the aluminum film 44 is formed on the transcription mold 41, the substrate 45 is adhered onto the aluminum film 44. An adhesive, for example, is used for the adhesion. A glass substrate, aluminum substrate, or the like is used for the substrate 45. However, since the substrate unit 42 is separated from the transcription mold 41 in a subsequent processing step, a mold-separating agent is preliminarily interposed between the transcription mold 41 and the aluminum film 44 in order to increase the separation effect.

A central hole 46 is formed in the center of the transcription mold 41. The diameter of the center hole 46 is set to be equal to the diameter of the through hole 17 or 21. Further, a central hole 47 is formed in the center of the aluminum film 44 formed on the transcription mold 41. The diameter of the center hole 47 is set to be identical to the diameter of any one of the through holes 17 and 21 and the center hole 46. Further, a central hole 48 is formed in the center of the substrate 45 formed on the aluminum film 44. The diameter of the center hole 48 is set to be smaller than the diameter of the pin 22. In the present case, the diameter of the center hole 48 is set to be 7.0 mm, for example. In other words, the diameter of the pin 22 is set to be larger than the diameter of the center hole 48 and smaller than the diameter of any one of the through holes 17 and 21 and the center holes 46 and 47. In this manner, the center hole 47 of the aluminum film 44 is locally covered by the substrate 45.

As shown in FIG. 7, in the process of mounting the transcription mold 41 and the substrate unit 42 to the upper base 13, the pin 22 is inserted into the through holes 17 and 21. The leading end of the pin 22 is inserted to extend from the surface of the upper base 13 through the through hole 17. The pin 22 is inserted into, for example, the central hole 46 of the transcription mold 41 and the center hole 47 of the aluminum film 44. Thereby, the pin 22 is used for positioning of the transcription mold 41 and the substrate unit 42. As a consequence, the transcription mold 41 and the substrate unit 42 are mounted in predetermined positions of the fixation apparatus 11. As described above, the transcription mold 41 is formed from the magnetic material such as Ni. As a consequence, the transcription mold 41 is attracted to the surface of the upper base 13 by magnetic forces from the magnets 23. In the present case, the attraction force of the transcription mold 41 is set to be 3×9.8 [N], for example. However, the attraction force is not limited to the value.

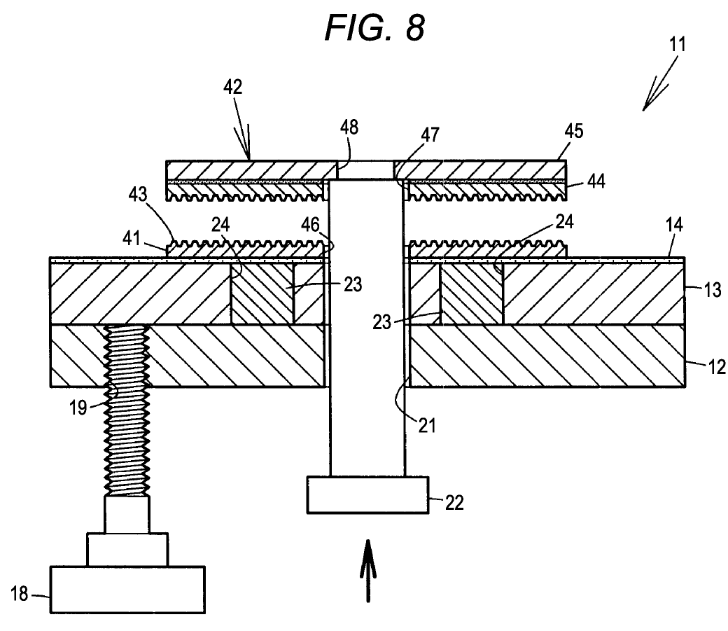

Further, since the diameter of the pin 22 is larger than the diameter of the central hole 48, the leading end of the pin 22 contacts the substrate 45 in the state shown in FIG. 7. As described above, the pin 22 is formed from resin material. By virtue of flexibility of the resin material, damage to the substrate 45 can be prevented as much as possible even while the pin 22 and the substrate 45 are in contact with each other. However, only the leading end may be formed from the resin material. As long as possible damage on the substrate 45 is prevented, the construction, material, and the like of the pin 22 are not specifically limited. In this case, the pin 22 is lifted by a predetermined lifting force along the vertical direction perpendicular to the surface of the substrate 45. As a consequence, the pin 22 provides the lifting force acting on the substrate 45, thereby causing the substrate 45 to be pushed up. The lifting force of the pin 22 is set to be lower than the attraction force of the transcription mold 41 that is attracted to the surface of the upper base 13. The lifting force is set to a value sufficient to separate the substrate unit 42 from the transcription mold 41. For example, the lifting force is set to 1×9.8 [N], although it is not limited to such a value. With reference to FIG. 8, when the lifting force thus acts along the direction from the pin 22 to the substrate 45, the substrate unit 42 separates from the surface of the transcription mold 41. In this case, the transcription mold 41 is maintained in the state it is attracted onto the upper base 13. In this manner, the transfer pattern of the transcription mold 41 is transferred onto the surface of the aluminum film 44.

Thereafter, the screw 18 is turned and is thereby inserted into the threaded screw hole 19. By insertion of the screw 18, the upper end of the screw 18 is received by the reverse face of the upper base 13. When the screw 18 is further inserted, a vertical force for pushing up the upper base 13 acts on the upper base 13. As described above, the lower and upper bases 12 and 13 are coupled together by the coupling mechanism 25. The spacer 28 is movable inside the bush 31 along the central axis of the bush 31. As a consequence, as the screw 18 is inserted into the threaded screw hole 19, the upper base 13 is slidingly moved by being guided by the support member. Thereby, the upper base 13 is spaced apart from the lower base 12 along the axial centers of the respective screws 15. As the distance between the lower and upper bases 12 and 13 increases, the distance between the respective magnet 23 and the transcription mold 41 increases.

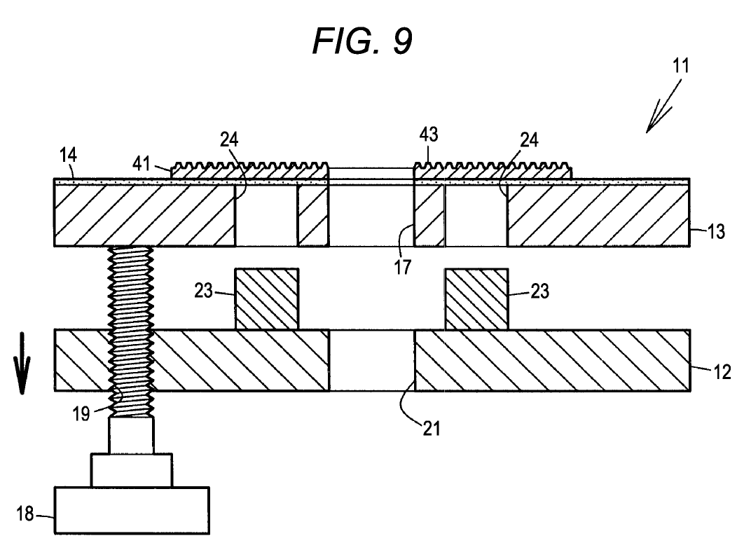

As a consequence, as shown in FIG. 9, the magnets 23 are completely withdrawn from the through hole 24. Since the distance between the respective magnet 23 and the transcription mold 41 increases, the intensity of the magnetic forces acting on the transcription mold 41 from the respective magnets 23 is reduced. As a consequence, the attraction force of the transcription mold 41 to the upper base 13 is reduced. In this manner, the transcription mold 41 is easily detached or removed from the surface of the upper base 13. A cleaning process is applied to the removed transcription mold 41. Thereby, the mold-separating agent remaining on the surface of the transcription mold 41 is washed away. In addition, an anodizing process is applied to the surface of the aluminum film 44 of the substrate unit 42. With the anodizing process, the aluminum so-called “nanoholes” are formed in the surface of the film 44. The nanoholes formed in the substrate unit 42 are filled with magnetic grains. In this manner, a patterned medium, i.e., a magnetic disk, which uses the substrate unit 42, is manufactured.

In the fixation apparatus 11 described above, the magnets 23 are mounted to the lower base 12. After the substrate unit 42 is separated from the transcription mold 41, the magnets 23 are spaced apart from the transcription mold 41 as the upper base 13 is spaced apart from the lower base 12 in operative association with insertion of the screw 18. As the distance between the respective magnet 23 and the transcription mold 41 increases, the intensity of the magnetic forces acting on the transcription mold 41 from the respective magnets 23 is reduced. As a consequence, the transcription mold 41 can easily be removed from the surface of the upper base 13. In the event that the transcription mold 41 is removed from the upper base 13, the likelihood of damage to the transcription mold 41 is reduced. Hence, in the present embodiment, the transcription mold 41 can be used again.

Further, the magnetic forces of the magnets 23 are used to removably attach the transcription mold 41 to the upper base 13. In the present embodiment, an adhesive material, such as an adhesive tape, for adhering the transcription mold 41 to the upper base 13 is not necessary. As such, the occurrence of foreign matter, for example, such as an organic substance on the adhesive tape, and the resulting contamination associated with the adhesive can be prevented. However, when the adhesive is used to attach the transcription mold, contamination occurs from the foreign matter, such as the adhesive, and contamination, for example. In the event of transfer of a fine pattern, there is a likelihood that the influence of such contamination causes a deficiency in the transfer pattern that is to be formed on the surface of the aluminum film. Further, since it takes time and labor to remove the transcription mold from the upper base, there is a likelihood that the transcription mold removed from the upper base is damaged. However, according to the present embodiment, the likelihood of deficiency in the transfer pattern can be reduced. Further, the transcription mold 41 can easily be removed from the upper base 13.

Further, the magnets 23 are disposed at equal intervals in the virtual regular circle on the surface of the lower base 12. As a consequence, the overall surface of the transcription mold 41 can be uniformly and evenly attracted to the surface of the upper base 13. The transcription mold 41 can be disposed on the surface of the lower base 12 without warping. In this case, it is preferable that the magnetic forces of the magnets 23 act on the circumference of the central hole 46 of the transcription mold 41. As described above, in the present embodiment, the magnets 23 surround the circumference of the through hole 17. As a consequence, in the event of separation of the substrate unit 42 from the transcription mold 41, the transcription mold 41 is prevented from being detached from the upper base 13 even by the lifting force acting on the substrate unit 42. For example, an inconvenience that the transcription mold 41 is locally separated from the upper base 13 is prevented. As a consequence, an inconvenience that the aluminum film 44 is locally separated from the substrate 45 is prevented, for example.

### Modified Example of First Embodiment

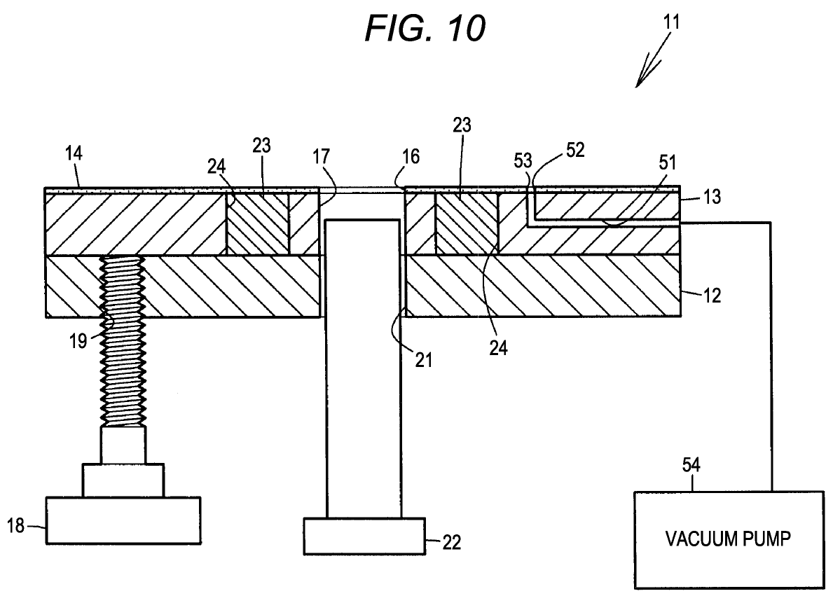

FIG. 10 shows a modified example (fixation apparatus 11) of the first embodiment. As shown in FIG. 10, an intake path 51 may be formed in the upper base 13. One end of the intake path 51 section-forms an inlet 52 on the surface of the upper base 13. When the transcription mold 41 is disposed on the surface of the upper base 13, the inlet 52 is blocked by the transcription mold 41. The inlet 52 can be formed to be exposed inside an opening 53 formed in the sheet 14. A vacuum pump 54 is coupled to the other end of the intake path 51. Other portions and sections having configurations and constructions corresponding to those described above are shown with the same reference numerals.

In the fixation apparatus 11 thus configured, the vacuum pump 54 draws air out of the intake path 51. An attraction force acts on the transcription mold 41 at the inlet 52. In this manner, the transcription mold 41 is attached to the upper base 13 by an even higher attraction force in addition to the attraction forces of the magnets 23. In particular, when the transcription mold 41, the substrate unit 42, and the like are large in size, the transcription mold 41 has to be attached to the upper base 13 with an even higher attraction force. In the example shown in FIG. 10, the transcription mold 41 is attracted to the upper base 13 by use of the vacuum pump 54 in addition to the magnets 23. As a consequence, an even higher attraction force can be secured. Hence, the degree of attraction of the transcription mold 41 to the upper base 13 is increased.

### Second Embodiment

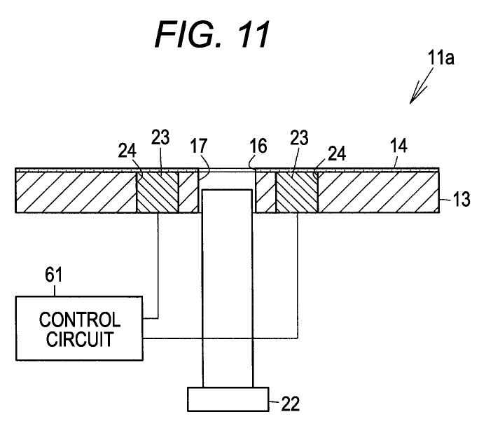

FIG. 11 is a schematic view showing the structure of a fixation apparatus 11a according to a second embodiment of the invention. In the fixation apparatus 11a of the second embodiment, the members such as the lower base 12 and screw 18 of the first embodiment are omitted. Further, for example, electromagnets are used for the magnets 23 in the second embodiment. The regulating mechanism, namely, a control circuit 61, is coupled to the magnets 23. The control circuit 61 supplies electric current to coils (not shown) of the respective magnets 23. The respective magnet 23 generates the magnetic force in accordance with the electric current supplied from the control circuit 61. Further, the intensity of the magnetic forces of the magnets 23 is adjusted in accordance with the increase or reduction in the amount of the electric current supplied from the control circuit 61. Similar to the first embodiment, the transcription mold 41 to be fixed onto the fixation apparatus 11a includes the magnetic material, and thus, the transcription mold 41 is attracted to the surface of the upper base 13.

Similarly as in the first embodiment, in the event of separation of the substrate unit 42 from the transcription mold 41, the substrate 45 is lifted by the pin 22. Thereby, the substrate unit 42 is separated from the surface of the transcription mold 41. Thereafter, the supply of the electric current to the magnets 23 is stopped, whereby the magnetic forces of the magnets 23 are terminated. As a consequence, the transcription mold 41 is easily removed from the upper base 13. However, when the transcription mold 41 is removed from the upper base 13, the supply of the electric current to the magnets 23 need not be completely stopped. The amount of the electric current supplied to the magnets 23 from the control circuit 61 can be reduced to an amount that enables the transcription mold 41 to be easily removed. The other configurations and structures corresponding to those of the fixation apparatus 11 are shown with the same reference numerals. According to the fixation apparatus 11a described above, effects and advantages similar to those described above can be realized. Further, although the screw 18 used in the first embodiment is not used, the transcription mold 41 can easily be removed from the upper base 13.

According to an aspect of the invention described above, the transcription mold fixation apparatus and the substrate removing method that enable the transcription mold to be re-usably held can be provided.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

The turn of the embodiments isn't a showing the superiority and inferiority of the invention. Although the embodiments of the present inventions have been described in detail, it should be understood that the various changes, substitutions, and alterations could be made hereto without departing from the spirit and scope of the invention.

What is claimed is:

1. A transcription mold fixation apparatus comprising:
a support base that receives on a surface thereof a transcription mold including a center hole formed therein and containing a magnetic material, the support base having a through hole aligned to the center hole;
a magnet that is incorporated in the support base and that fixes the transcription mold to the surface of the support base;
a pin that extends through the through hole; and
a regulating mechanism that spaces the magnet in relation to the magnetic material.

2. The transcription mold fixation apparatus according to claim 1, wherein movement of the pin is guided by the through hole along a direction of an axial center thereof.

3. A transcription mold fixation apparatus, comprising:
a support base that receives on a surface thereof a transcription mold including a center hole formed therein and containing a magnetic material, the support base having a through hole aligned to the center hole;
an electromagnet incorporated in the support base which generates a magnetic force in accordance with an electric current supply, which thereby fixes the transcription mold to the surface of the support base;
a regulating mechanism that is coupled to the electromagnet which regulates an intensity of the magnetic force by increasing or reducing an amount of the electric current supplied to the electromagnet; and
a pin that extends through the through hole so that a leading end of the pin extends to the center hole of the transcription mold.

4. The transcription mold fixation apparatus according to claim 3, wherein the pin is positioned so that movement thereof is guided along an axial center direction of the through hole.

5. A substrate removing method comprising the steps of:
disposing a transcription mold on a surface of a support base, the transcription mold defining a center hole formed therein and containing a magnetic material;
fixing the transcription mold to the surface of the support base by causing a magnetic force to act on the magnetic material from a magnet incorporated in the support base;
inserting a pin into the center hole of the transcription mold via a through hole formed in the support base aligned with the center hole, thereby causing a leading end of the pin to lift a substrate that is adhered to a transfer-target film formed on a surface of the transcription mold; and
causing the magnet to be spaced apart from the magnetic material, thereby reducing an intensity of the magnetic force acting on the magnetic material.

6. The substrate removing method according to claim 5, wherein movement of the pin is guided by the through hole along an axial center direction thereof.

7. A substrate removing method comprising the steps of:
disposing a transcription mold on a surface of a support base, the transcription mold having a center hole formed therein and containing a magnetic material;
fixing the transcription mold to the surface of the support base by supplying an electric current to an electromagnet incorporated in the support base to thereby cause a magnetic force from the electromagnet to act on the magnetic material;
inserting a pin into the center hole via a through hole formed in the support base to contact a substrate, thereby causing a leading end of the pin to lift the substrate that is adhered to a transfer-target film formed on a surface of the transcription mold; and
reducing the amount of the electric current supplied to the electromagnet, thereby reducing an intensity of the magnetic force acting on the magnetic material.

8. The substrate removing method according to claim 5, wherein movement of the pin is guided by the through hole along an axial center direction thereof.
